(19) United States
(12) Patent Application Publication
(10) Pub. No.: US 2016/0347282 A1
(43) Pub. Date: Dec. 1, 2016

(54) KEYLESS HANDOFF CONTROL

(71) Applicant: Ford Global Technologies, LLC, Dearborn, MI (US)

(72) Inventor: Venkatesh Krishnan, Canton, MI (US)

(73) Assignee: FORD GLOBAL TECHNOLOGIES, LLC, Dearborn, MI (US)

(21) Appl. No.: 14/726,748

(22) Filed: Jun. 1, 2015

(51) Int. Cl. B60R 25/20; B60R 25/24; G05D 1/00

(52) U.S. Cl. CPC B60R 25/209; G05D 1/0016; G05D 1/0022; B60R 25/24

(57) ABSTRACT

A vehicle system includes a communication module programmed to receive a handoff mode signal from a remote device. A processing device is programmed to receive the handoff mode signal and enable a vehicle handoff mode in response to receiving the handoff mode signal. An input device is programmed to receive a temporary code, and in response, the processing device is programmed to enable the vehicle handoff mode.

### BACKGROUND

Passive entry and remote start systems are two convenient vehicle features. A passive entry system allows a vehicle owner to enter an otherwise locked vehicle and start the vehicle simply by bringing a remote transmitter near the vehicle. The passive entry system will cause the vehicle doors to unlock as soon as the remote transmitter is detected near the vehicle. Moreover, the owner can start the vehicle by simply pressing a button so long as the remote transmitter is nearby. Remote start systems allow a vehicle owner to start the vehicle remotely without inserting a key into the ignition cylinder. Thus, the vehicle can warm up or cool down the passenger compartment prior to the owner entering the vehicle.

### BRIEF DESCRIPTION OF THE DRAWINGS

FIG. 1 illustrates an example vehicle having a system for operating the car in a keyless handoff mode in response to a signal from a remote device.

FIG. 2 illustrates example components of the system shown in FIG. 1.

FIG. 3 is a flowchart of an example process that may be executed by the vehicle to initiate the handoff mode.

FIG. 4 is a flowchart of an example process that may be executed by the vehicle to disable the handoff mode.

FIG. 5 is a flowchart of an example process for activating the handoff mode from a remote device.

FIG. 6 is a flowchart of an example process for permitting access to the vehicle, from the remote device, after the vehicle is done operating in the handoff mode.

FIG. 7 is an example graphical user interface for setting parameters associated with the handoff mode.

### DETAILED DESCRIPTION

Advancements in passive entry and remote start systems may permit vehicle manufacturers to eliminate keys and the corresponding hardware (cylinders, etc.) from vehicles equipped with such systems. Doing so, however, may complicate vehicle handoffs, which often occur in the context of car sharing programs, vehicle rentals, and valet services. An example vehicle system that facilitates vehicle handoffs for keyless vehicles includes a communication module programmed to receive a handoff mode signal from a remote device, such as a mobile phone or fob. The system further includes a processing device programmed to receive the handoff mode signal and enable a vehicle handoff mode in response to receiving the handoff mode signal. An input device, which may be located on a vehicle exterior, is programmed to receive a temporary code, and in response, the processing device is programmed to enable the vehicle handoff mode. With the system, a vehicle owner can grant temporary access to the vehicle. Moreover, through the remote device, the vehicle owner is able to implement certain restrictions related to the use of the vehicle while operating in the handoff mode.

The elements shown may take many different forms and include multiple and/or alternate components and facilities. The example components illustrated are not intended to be limiting. Indeed, additional or alternative components and/or implementations may be used.

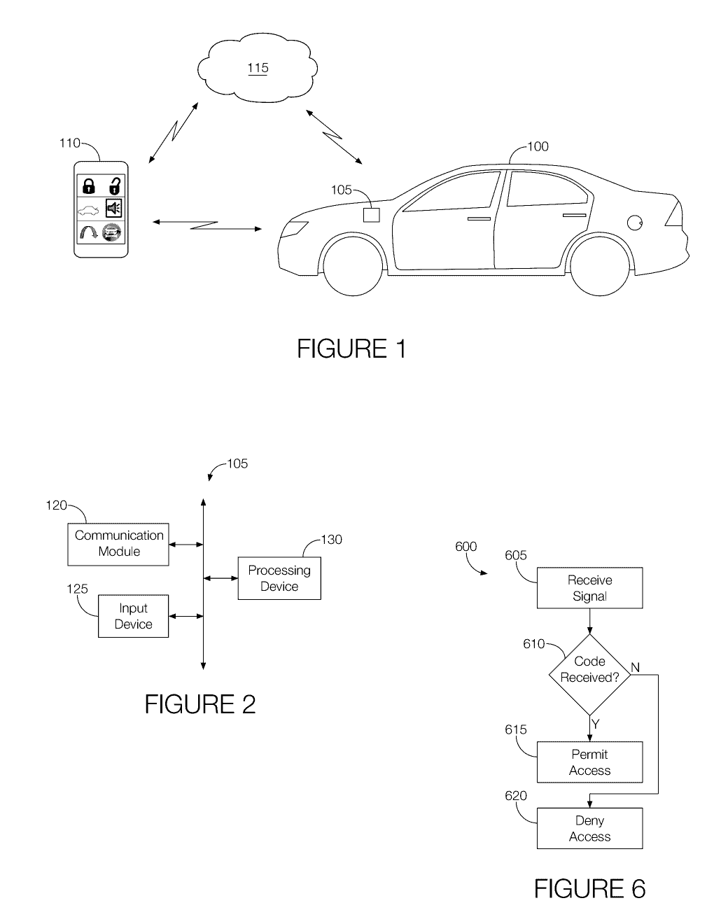

As illustrated in FIG. 1, the host vehicle 100 includes a handoff system 105 for operating the host vehicle 100 in a keyless handoff mode. The handoff system 105 may receive signals transmitted from a remote device 110. The remote device 110 may transmit signals over a communication network 115 and in accordance with any number of communication protocols. In some instances, the remote device 110 may communicate directly with the handoff system 105. That is, the remote device 110 may pair with the handoff system 105 and communicate in accordance with a protocol such as, e.g., Bluetooth®. Accordingly, the remote device 110 may include, e.g., a mobile phone, a tablet computer, a fob, or the like. The communication network 115 may include one or more telecommunications networks including a cellular network, a satellite-based network, a radio frequency network, etc.

Although illustrated as a sedan, the host vehicle 100 may include any passenger or commercial automobile such as a car, a truck, a sport utility vehicle, a crossover vehicle, a van, a minivan, a taxi, a bus, etc. In some possible approaches, the host vehicle 100 is an autonomous vehicle configured to operate in an autonomous (e.g., driverless) mode, a partially autonomous mode, and/or a non-autonomous mode.

Referring now to FIG. 2, the handoff system 105 may include a communication module 120, an input device 125, and a processing device 130.

The communication module 120 may include any electronic device programmed to transmit signals to, or receive signals from, the remote device 110. The communication module 120 may be programmed to communicate over the communication network 115 in accordance with any number of communication protocols. For example, the communication module 120 may be programmed to communicate over a cellular network, a satellite network, via radio frequency signals, etc. The communication module 120 may be programmed to receive a handoff mode signal transmitted from the remote device 110. The handoff mode signal may cause the host vehicle 100 to operate in a handoff mode that may include certain restrictions. For instance, the handoff mode signal may include parameters such as a maximum driving speed, a maximum driving distance, or the like. The communication module 120 may be in signal communication with the processing device 130, and therefore, may transmit the received handoff mode signal to the processing device 130.

The input device 125 may include any electronic device programmed to receive, e.g., a code. The input device 125 may include a keypad located on an exterior of the host vehicle 100. The keypad may include real or virtual buttons. In some instances, the input device 125 may include a touch-sensitive display screen. The input device 125 may be programmed to generate a signal according to inputs received. An input may be received when a person presses the buttons on the input device 125. The signal output by the input device 125 may represent the buttons pressed, including the order in which the buttons are pressed. In addition or alternatively, the input device 125 may include other technology such as a finger print reader or a retina scanner to identify an authorized user. The input device 125 may be in signal communication with the processing device 130. Therefore, the input device 125 may output, to the processing device 130, a signal representing the buttons pressed.

The processing device 130 may be programmed to receive and process the handoff mode signal. In response to receiving the handoff mode signal, the processing device 130 may output a signal that causes the host vehicle 100 to operate in a handoff mode. The handoff mode may include certain operating restrictions identified by parameters transmitted with, e.g., the handoff mode signal. Example parameters may include, e.g., a maximum driving speed, a maximum driving distance, etc. Other parameters may limit access to certain parts of the vehicle. For instance, the parameters could prevent the operator from opening the glove box, center console, trunk, or hood. Thus, it is possible to allow someone, such as a valet, to operate the host vehicle 100 without giving that person unfettered access to the host vehicle 100.

In addition to causing the host vehicle 100 to operate in the vehicle handoff mode, the processing device 130 may be programmed to generate a temporary code. The temporary code, when provided to the input device 125, may provide access to the passenger compartment of the host vehicle 100, as well as start the host vehicle 100. Therefore, providing the temporary code may unlock the vehicle doors, start the vehicle engine, or both. The processing device 130 may be programmed to transmit the temporary code to, and in some instances receive the temporary code from (i.e., for purposes of unlocking the vehicle 100), the remote device 110 by way of the communication module 120.

The processing device 130 may be programmed to disable the handoff mode, thus returning the host vehicle 100 to normal operation, when the host vehicle 100 has been returned to its owner. For example, the remote device 110 may transmit a disable signal to the processing device 130 via the communication module 120. The disable signal may indicate that the owner is present and wishes to disable the handoff mode. In response to receiving the disable signal, the processing device 130 may output a command for the host vehicle 100 to resume normal operations, including removing the maximum speed and driving distance set during the handoff mode.

Moreover, the processing device 130 may be programmed to update certain parameters associated with the handoff mode. The parameters may be updated prior to the host vehicle 100 operating in the handoff mode or while the vehicle is operating in the handoff mode. The updated parameters may include setting a new maximum speed, a new maximum driving distance, or both. The update signal identifying the updated parameters may be transmitted from the remote device 110 to the host vehicle 100. The communication module 120 may be programmed to receive the update signal and transmit the update signal to the processing device 130, which may be programmed to carry out instructions incorporated into the update signal.

In certain instances, such as when the host vehicle 100 is turned over to a valet, the handoff mode may be implemented twice—first when the remote device 110 transmits the handoff mode signal to the host vehicle 100 and again when the valet enters the temporary code via the input device 125. Therefore, the vehicle owner may, using the remote device 110, transmit the handoff mode signal at the time the owner hands over the host vehicle 100 to the valet. The remote device 110 may receive and display the temporary code generated by the processing device 130. The owner can write down the temporary code for the valet or give the temporary code to the valet when the owner wishes to pick up his or her vehicle. After the valet enters the temporary code, the host vehicle 100 may unlock and operate the host vehicle 100 in the handoff mode. Alternatively, the vehicle owner can disable the handoff mode by entering the temporary code at the host vehicle 100 or via the remote device 110.

If the parameters associated with the handoff mode are too restrictive (e.g., the maximum driving distance is too short for the valet to park the host vehicle 100), the valet may request that the parameters be updated. In response, the owner may, using the remote device 110, update the parameters to, e.g., set a longer maximum driving distance. The remote device 110 may transmit the update signal to the host vehicle 100, and the processing device 130 may allow the host vehicle 100 to operate in accordance with the updated driving distance.

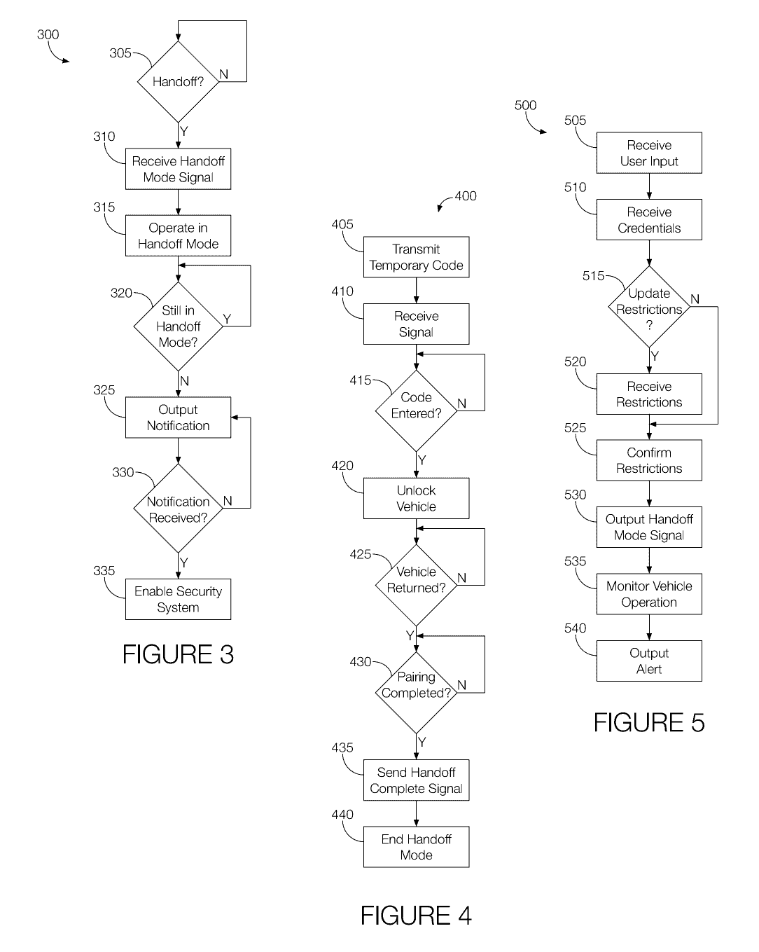

FIG. 3 is a flowchart of an example process 300 that may be executed by the handoff system 105 to initiate the handoff mode. The process 300 may begin when the host vehicle 100 is handed over to, e.g., a valet or other driver who is given temporary and limited authority to operate the host vehicle 100. The process 300 assumes that the host vehicle 100 is running (e.g., the engine is already or still on).

At decision block 305, the handoff system 105 may determine whether a handoff is about to begin or has already begun. For instance, a handoff may begin when the occupants have exited the host vehicle 100 while the engine of the host vehicle 100 is still on. The processing device 130 may make such a determination based on signals received from various vehicle sensors. If the handoff has begun, the process 300 may proceed to block 310. Otherwise, the process 300 may return to block 305.

At block 310, the handoff system 105 may receive the handoff mode signal from the remote device 110. The handoff mode signal may include an instruction for the host vehicle 100 to operate in the handoff mode. In some instances, the host vehicle 100 may be subject to various operating restrictions while operating in the handoff mode. The operating restrictions may be transmitted along with the handoff mode signal, may be identified prior to the process 300 beginning, or received through other means. As discussed above, the operating restrictions may include setting a maximum driving speed, a maximum driving distance, preventing access to the trunk and glove compartment, etc. The handoff mode signal may be received by the communication module 120 and processed by the processing device 130.

At block 315, the handoff system 105 may output signals to cause the host vehicle 100 to operate in the handoff mode. While operating in the handoff mode, the host vehicle 100 may be subject to the driving restrictions discussed above.

At decision block 320, the handoff system 105 may determine whether the host vehicle 100 is still operating in the handoff mode. The processing device 130 may make such a determination from signals received from various vehicle sensors. The processing device 130 may determine that the host vehicle 100 is still operating in the handoff mode if e.g., the host vehicle 100 is still moving, there is an occupant in the host vehicle 100, the engine is turned on, the doors are unlocked, etc. If the host vehicle 100 is no longer operating in the handoff mode, the process 300 may proceed to block 325. Otherwise, the process 300 may continue to execute block 320 until the vehicle is no longer operating in the handoff mode.

At block 325, the handoff system 105 may notify the owner of the host vehicle 100 that the host vehicle 100 is no longer operating in the handoff mode. For instance, the processing device 130 may wirelessly transmit a message to the remote device 110 via the communication module 120. The message may indicate that the host vehicle 100 has been parked. In some instances, the message may include location information or images captured from a camera located on the host vehicle 100. With the location information and images, the user can better confirm whether the host vehicle 100 is truly parked or temporarily stopped.

At decision block 330, the handoff system 105 may determine whether the remote device 110 received the message transmitted at block 325. The processing device 130, for instance, may determine that the remote device 110 has received the message based on an acknowledgement signal transmitted from the remote device 110 to the handoff system 105. The processing device 130 may receive the acknowledgement signal via the communication module 120. If the remote device 110 has received the message, the process 300 may proceed to block 335. Otherwise, the process 300 may return to block 325 to retransmit the message. The process 300 may return to block 325 after a short delay to give the remote device 110 time to receive the message and send the acknowledgement signal.

At block 335, the handoff system 105 may receive a confirmation from the user, sent via the remote device 110, to enable a security system. The processing device 130 may process the signal received and output command signals that cause the host vehicle 100 to enable the security system. Enabling the security system may further include confirming that all doors are closed and locked and sending appropriate signals to close and lock the doors if not. The process 300 may end after block 335.

FIG. 4 is a flowchart of an example process 400 that may be executed by the host vehicle 100 to disable the handoff mode. The process 400 may be executed, therefore, after the process 300 discussed above ends, such as when a vehicle owner would like a valet to retrieve the host vehicle 100 from its parking spot.

At block 405, the handoff system 105 may transmit the temporary code to the remote device 110. The temporary code may be generated by the processing device 130 and transmitted to the remote device 110 using the communication module 120. In some instances, the handoff system 105 may transmit the temporary code to the remote device 110 at the time the handoff begins (at blocks 305 or 310 of the process 300 described above).

At block 410, the handoff system 105 may receive a signal from the remote device 110 indicating that the host vehicle 100 will be returned to the owner. The signal may include, e.g., the handoff mode signal which may include driving restrictions such as a maximum driving speed and maximum driving distance. The signal may be received via the communication module 120 and processed by the processing device 130.

At decision block 415, the handoff system 105 may determine whether the temporary code has been entered into the input device 125. The input device 125 may transmit one or more signals representing the buttons pressed or whether the correct temporary code has been entered to the processing device 130. The processing device 130 may determine whether the temporary code has been entered based on the signals received from the input device 125. If the temporary code has been entered, the process 400 may proceed to block 420. Otherwise, block 415 may be repeated until the temporary code is received.

At block 420, the handoff system 105 may unlock the host vehicle 100 and start the engine. Unlocking the doors may permit a valet or other driver to enter the host vehicle 100. Starting the engine may allow the valet or other driver to operate the host vehicle 100 without a key.

At decision block 425, the handoff system 105 may determine whether the host vehicle 100 has been returned to its owner. For instance, the processing device 130 may determine whether the remote device 110 is near the host vehicle 100 based on, e.g., whether the remote device 110 has paired with the host vehicle 100. Additionally or in the alternative, the processing device 130 may determine whether the host vehicle 100 has been returned based on whether the door has been opened and whether the valet or other driver has exited the host vehicle 100. If the host vehicle 100 has been returned, the process 400 may proceed to block 430. Otherwise, the process 400 may continue to execute block 425 until the host vehicle 100 has been returned.

At decision block 430, the handoff system 105 may determine whether the host vehicle 100 has paired with the remote device 110. The processing device 130 may determine whether the host vehicle 100 and remote device 110 have paired based on, e.g., signals received from the remote device 110, the host vehicle 100, or both. If the pairing has occurred, the process 400 may proceed to block 435. Otherwise, the process 400 may continue to execute block 430 until the remote device 110 has paired with the host vehicle 100.

At block 435, the handoff system 105 may send a signal to the remote device 110 asking the user to confirm that the handoff has been completed and that the handoff mode is no longer desired. The processing device 130 may generate such a signal and may transmit the signal to the remote device 110 by way of the communication module 120. The message represented by the signal may be presented to the user on the remote device 110.

At block 440, the handoff system 105 may receive a confirmation signal indicating that the user has confirmed the completion of the handoff. The confirmation signal may be received via the communication module 120 and processed by the processing device 130. After processing the confirmation signal, the processing device 130 may output signals that cause the host vehicle 100 to resume normal operation, that is, without the driving restrictions that were in place while operating in the handoff mode. The process 400 may end after block 440.

FIG. 5 is a flowchart of an example process 500 for activating the handoff mode from the remote device 110 according to a number of parameters. The process 500 may be initiated in response to, e.g., a user input provided to the remote device 110. The user input may execute an application that may follow the process 500. Alternatively or in addition, although the process 500 is generally discussed in the context of a remote device 110, the process 500 may be executed inside the host vehicle 100 using a built-in user interface device with a touch-sensitive display screen and context-sensitive menus and prompts.

At block 505, the application may receive a user input indicating that the user desires for the host vehicle 100 to operate in the handoff mode. The user input may be provided to the application via a user input device 125.

At block 510, the application may receive user credentials. The credentials may include a user name, password, PIN number, etc. The remote device 110 may prompt the user to provide such credentials after, e.g., block 505.

At decision block 515, the application may determine whether driving restrictions need to be set or updated. For example, the application may present the previously set driving restrictions, a list of default driving restrictions, a list of possible driving restrictions, or the like. If the driving restrictions are to be set or updated, the process 500 may proceed to block 520. Otherwise, the process 500 may proceed to block 525.

At block 520, the application may receive user inputs identifying the desired driving restrictions for operating the host vehicle 100 in the handoff mode. The user inputs may include a user selection of e.g., a maximum driving speed, a maximum driving distance, an indication of whether the valet or other driver will have access to the glove box, center console, trunk, fuel tank, infotainment system, etc.

At block 525, the application may prompt the user to confirm the driving restrictions. The process 500 may proceed to block 530 after such a prompt is received.

At block 530, the application may generate and output the handoff mode signal. In the case of the remote device 110, the handoff mode signal may be transmitted to the host vehicle 100. If the application is incorporated into, e.g., the infotainment system of the host vehicle 100, the infotainment system may output the handoff mode signal to the handoff system 105.

At decision block 535, the application may continuously monitor the operation of the host vehicle 100 while the host vehicle 100 is operating in the handoff mode. In some instances, the handoff system 105 may prevent the host vehicle 100 from violating the driving restrictions (i.e., the handoff system 105 will not allow the host vehicle 100 to travel at a speed greater than the maximum driving speed or at a distance beyond the maximum driving distance). In instances where the handoff system 105 does not control the host vehicle 100 in that manner, the application may determine whether the driving restrictions have been violated. That is, the application may monitor the speed and distance of the host vehicle 100 to determine whether, e.g., the maximum speed, the maximum distance, or both, have been violated. If a driving restriction has been violated, the process 500 may proceed to block 540. If no restriction has been violated, block 535 may be repeated until, e.g., the host vehicle 100 is parked and the engine turned off.

At block 540, the application may output an alert indicating that the driving restriction has been violated. The alert may be presented on the remote device 110. Where the application resides in the host vehicle 100, the alert may be transmitted by, e.g., the communication module 120, to the remote device 110. Where the application resides on the remote device 110, the application may receive periodic updates of the host vehicle 100 speed and distance sent by, e.g., the handoff system 105. The process 540 may end after block 540 or return to block 535 so that additional behavior of the host vehicle 100 may be monitored.

FIG. 6 is a flowchart of an example process 600 for permitting access to the host vehicle 100. The process 600 may be initiated by the handoff system 105 in response to, e.g., a user input provided to the remote device 110 and that user input being transmitted to the handoff system 105.

At block 605, the handoff system 105 may receive a signal representing a user input indicating that the user desires for the host vehicle 100 to be returned. The signal may be received by the communication interface and processed by the processing device 130. In some instances, the remote device 110 may display a temporary code that will give the valet or other driver temporary access to and ability to drive the host vehicle 100 subject to the driving restrictions discussed above.

At decision block 610, the handoff system 105 may determine whether the temporary code was received via the input device 125. The temporary code may be provided via, e.g., a keypad, and the input device 125 may output a signal to the processing device 130 in accordance with the real or virtual buttons pressed on the input device 125. If the processing device 130 determines that the received signal represents the temporary code, the process 600 may proceed to block 615. Otherwise, the process 600 may proceed to block 620.

At block 615, the handoff system 105 may permit access to the host vehicle 100 and allow the person who provided the temporary code to operate the host vehicle 100 subject to the handoff mode and the corresponding driving restrictions. The handoff system 105 may unlock the doors to the passenger compartment and start the engine. The handoff system 105 may update the driving restrictions including limiting the maximum vehicle speed and distance and keep the trunk, glove compartment, fuel door, and center console locked.

At block 620, the handoff system 105 may deny access based on the incorrect code applied. In some instances, the handoff system 105 may notify the owner of the incorrect attempt to access the host vehicle 100 by sending a signal to the remote device 110. The signal may be generated by the host device and transmitted to the remote device 110 over the communication network 115 via the communication module 120. The process 600 may return to block 605 or 610 after an incorrect temporary code has been provided to the input device 125.

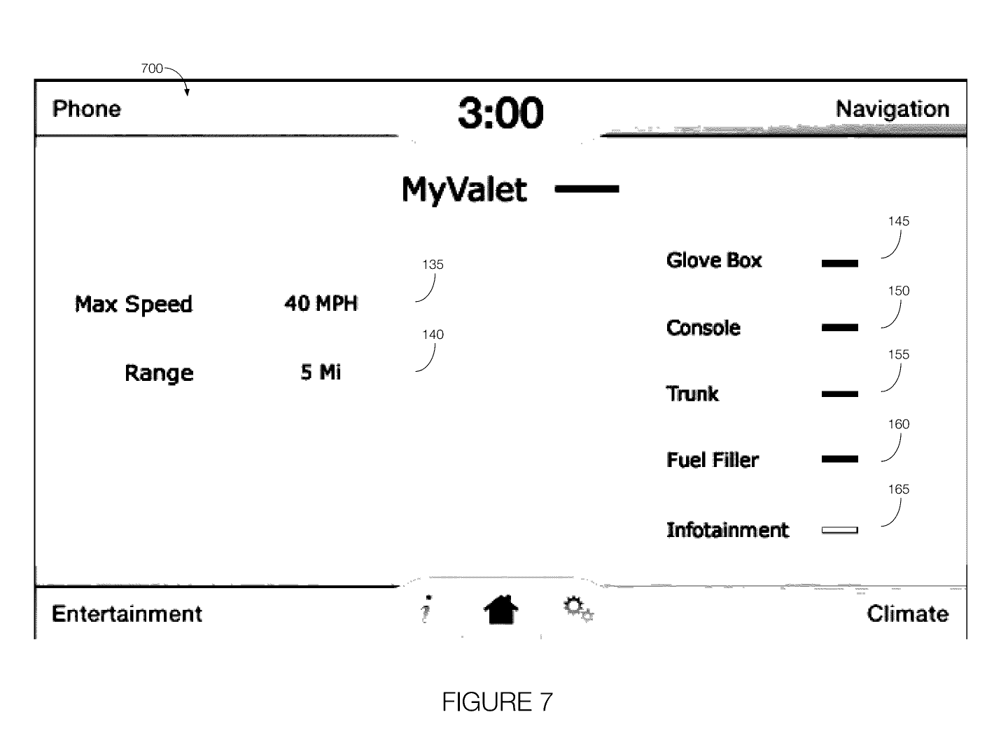

FIG. 7 is an example graphical user interface 700 for setting parameters associated with the handoff mode. The graphical user interface 700 may be incorporated into an application executed on the remote device 110 or inside the host vehicle 100. As shown, the graphical user interface 700 includes a maximum speed field 135, a maximum distance field 140, a glove box lock field 145, a console lock field 150, a trunk lock field 155, a fuel door lock field 160, and an infotainment system lock field 165. The maximum speed field 135 may receive a user input setting a maximum vehicle speed for when the host vehicle 100 is operating in the handoff mode. In the example of FIG. 7, the maximum vehicle speed has been set to 40 mph. The maximum distance field 140 may receive a user input setting a maximum vehicle distance for when the host vehicle 100 is operating in the handoff mode. In the example of FIG. 7, the maximum vehicle distance has been set to 5 miles. The glove box lock field 145, the console lock field 150, the trunk lock field 155, the fuel door lock field 160, and the infotainment system lock field 165 may receive a user input associated with locking the glove box, console, trunk, fuel door, and infotainment system, respectively, when the host vehicle 100 is operating in the handoff mode. Moreover, the glove box lock field 145, the console lock field 150, the trunk lock field 155, the fuel door lock field 160, and the infotainment system lock field 165 may include an indicator of whether the respective vehicle component will be locked. For instance, the indicator may appear one color, such as “red” (shown as black in the accompanying figures), when the corresponding component will be locked while the host vehicle 100 is operating in the handoff mode and another color, such as “green” or “white”, when the corresponding component will be unlocked while the host vehicle 100 is operating in the handoff mode.

In general, the computing systems and/or devices described may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a communication module programmed to receive a handoff mode signal from a remote device;
a processing device programmed to receive the handoff mode signal and generate a temporary code in response to receiving the handoff mode signal;
wherein the communication module is programmed to receive the temporary code from the processing device and transmit the temporary code to the remote device; and
an input device programmed to receive the temporary code via a user input, and
wherein the processing device is programmed to enable a vehicle handoff mode in response to the input device receiving the temporary code via the user input and after the communication module transmits the temporary code to the remote device.

2. The vehicle system of claim 1, wherein enabling the vehicle handoff mode includes setting a maximum vehicle speed.

3. The vehicle system of claim 1, wherein enabling the vehicle handoff mode includes setting a maximum vehicle distance.

4-6. (canceled)

7. The vehicle system of claim 1, wherein the processing device is programmed to unlock a vehicle door after the temporary code is received by the input device.

8. The vehicle system of claim 1, wherein the processing device is programmed to start a vehicle engine after the temporary code is received by the input device.

9. The vehicle system of claim 1, wherein the processing device is programmed to receive an update signal from the remote device, the update signal representing an updated parameter.

10. The vehicle system of claim 9, wherein the update signal is received by the communication module.

11. The vehicle system of claim 9, wherein the updated parameter includes at least one of an updated maximum vehicle speed and an updated maximum vehicle distance associated with the vehicle handoff mode.

12. A method comprising:
receiving a handoff mode signal from a remote device;
generating a temporary code in response to receiving the handoff mode signal;
transmitting the temporary code to the remote device;
receiving the temporary code via a user input provided to an input device, and
enabling the vehicle handoff mode in response to the input device receiving the temporary code via the user input and after transmitting the temporary code to the remote device.

13. The method of claim 12, wherein enabling the vehicle handoff mode includes setting a maximum vehicle speed.

14. The method of claim 12, wherein enabling the vehicle handoff mode includes setting a maximum vehicle distance.

15-16. (canceled)

17. The method of claim 12, further comprising unlocking a vehicle door and starting a vehicle engine after receiving the temporary code.

18. The method of claim 12, further comprising:
receiving an update signal from the remote device, the update signal representing an updated parameter; and
updating a handoff mode parameter in accordance with the updated parameter represented by the update signal.

19. The method of claim 18, wherein the updated parameter includes at least one of an updated maximum vehicle speed and an updated maximum vehicle distance associated with the vehicle handoff mode.

20. A vehicle system comprising:
a communication module programmed to receive a handoff mode signal from a remote device;
a processing device programmed to receive the handoff mode signal and generate a temporary code, wherein the communication module is programmed to transmit the temporary code to the remote device; and
an input device programmed to receive the temporary code via a user input,
wherein the processing device is programmed to enable a vehicle handoff mode in response to the input device receiving the temporary code and after the communication module transmits the temporary code to the remote device, wherein enabling the vehicle handoff mode includes setting a maximum vehicle speed and a maximum vehicle distance,
wherein the communication module is programmed to receive an update signal representing at least one updated parameter before the input device receives the temporary code and the processing device enables the handoff mode, and wherein the processing device is programmed to enable the vehicle handoff mode in accordance with the at least one updated parameter.
